(19) United States
(12) Patent Application Publication
(10) Pub. No.: US 2025/0312972 A1
(43) Pub. Date: Oct. 9, 2025

(54) KIT AND METHOD FOR RETROFITTING EXISTING THREE DIMENSIONAL ADDITIVE MANUFACTURING DEVICES

(71) Applicant: SprintRay, Inc., Los Angeles, CA (US)

(72) Inventors: Huijian Tian, Los Angeles, CA (US); Amir Mansouri, Los Angeles, CA (US); Eric Leal, Los Angeles, CA (US); Aayush Patel, Los Angeles, CA (US); Eduardo Ramirez, Los Angeles, CA (US)

(21) Appl. No.: 19/245,136

(22) Filed: Jun. 20, 2025

Related U.S. Application Data
(63) Continuation of application No. 18/244,380, filed on Sep. 11, 2023.
Application No. 18/244,380 is a continuation of application No. 18/133,521, filed on Apr. 11, 2023, now abandoned.
(60) Provisional application No. 63/329,847, filed on Apr. 11, 2022.

(51) Int. Cl. B29C 64/307; B33Y 30/00

(52) U.S. Cl. CPC B29C 64/307; B33Y 30/00

(57) ABSTRACT

A kit for retrofitting an existing three-dimensional (3D) printer and a method of retrofitting an existing a 3D printer are disclosed. The kit includes a kit adapter that comprises a resin reservoir. The reservoir includes a bottom print surface, the kit adapter adapted to register with an existing screen of the 3D printer. The method includes the steps of providing a kit adapter including a kit resin reservoir including a kit bottom print surface, the kit adapter adapted to register with the existing screen; registering the kit adapter with the existing screen thereby covering a second portion of the existing screen with the kit bottom print surface and thereby configuring the kit bottom surface to receive the curing light from the second portion of the existing screen only, wherein the second portion of the existing screen is contained within the first portion of the existing screen.

### PRIORITY OR RELATED APPLICATIONS

This application is a continuation of U.S. patent application Ser. No. 18/244,380 filed Sep. 11, 2024, which is a continuation of Ser. No. 18/133,521, filed on Apr. 11, 2023, which is a Non-provisional Application of, and claims priority to, U.S. Provisional Application No. 63/329,847, filed on Apr. 11, 2022, the disclosures of which are incorporated by reference in their entirety.

### TECHNICAL FIELD

The present invention generally relates to additive manufacturing devices. More specifically, the present invention relates to devices, systems, and methods for creating three-dimensional (3D) objects with additive manufacturing techniques that employ a single-use cartridge, which may be disposable or recyclable.

### BACKGROUND

3D printing is a process that creates three-dimensional objects by depositing materials, usually in layers. Additive manufacturing uses 3D modeling software to create designs or scan objects. The software then translates the design into a layer-by-layer framework for additive manufacturing. 3D printing encompasses several manufacturing technologies. Each technology differs in material selection, surface finish, durability, and manufacturing speed and cost. One among them is Digital Light Processing (DLP).

DLP is a process of creating objects by a 3D printer that uses a digital light projector as the light source for curing photo-reactive polymers. The DLP technology utilizes light and a liquid resin to make solid parts and products. The light source incident on the surface of the object being printed is controlled by micromirrors present in the system. In general, the DLP printers are built around a resin tank with a transparent bottom and a build platform at the top to create objects layer by layer. It is similar to Stereolithography (SLA) but differs in the use of the different light sources.

A process of additive manufacturing using Stereolithography has four essential components. It uses a Photopolymer, housed in a VAT, which is exposed to a Light source. The light from the light source initiates polymerization to convert liquid to solid on a build platform, to which the solid part attaches to. Current systems utilize a generalized VAT, which houses a high volume of photopolymer and uses large platforms to provide a high degree of versatility to print. This has a drawback in the form that more resin is needed to initiate prints and if a print fails, it brings a risk of wasting more volume of resin. Furthermore, the resin is poured at the discretion of the user who can either pour a high or low volume of resin which might cause a failed print.

Various additive manufacturing processes and technologies are known in the art, however, none of them provide solution as an additive manufacturing device with multiple tanks on the same printer (i.e., DLP printer) with single Z-axis control for printing multiple materials at once. Further, a disposable or reusable cartridge to build specific components with minimal resin handling is nowhere disclosed.

Therefore, there is a need for a 3D printing device to print multiple materials at once. Also, there is a need for a device with a disposable or single-use cartridge that minimizes waste and obviates the need for some equipment. Further, there is a need for a cartridge, container, or tank assembly that minimizes the forming material waste during small batch printing. It is to these ends that the present invention has been developed.

### SUMMARY OF THE INVENTION

The present invention generally discloses an additive manufacturing device that employs a single-use cartridge or reservoir assembly adapted to minimize forming material waste during small batch printing.

In exemplary embodiments, the cartridge, which may be disposable or recyclable, includes a built-in forming material reservoir and build plate that is utilized by an additive manufacturing device to form a single 3D object.

According to some aspects of the present invention, the additive manufacturing device may be referred to as a 3D printer. The 3D printer may comprise a container or cartridge-based resin tank that may be pre-filled and sealed with a forming material such as a light-curable resin. In some exemplary embodiments, the cartridge-based resin tank with light-cured resin is an innovative and intelligent solution that has been designed to allow operators to go through the print process with minimal resin handling and eliminates the need to measure the amount of resin during setup. In some exemplary embodiments, the resin is in a form of liquid or paste. The resin is hardened using visible and/or ultraviolet (UV) light. In some exemplary embodiments, the cartridge-based resin tank comprises a penetrable layer or sealing layer on its top side. The penetrable layer is configured to seal the resin. In some exemplary embodiments, the cartridge-based resin tank further comprises an optically clear layer on another side. The optically clear layer is configured to allow the passage of UV light to initiate polymerization.

In some exemplary embodiments, the cartridge-based resin tank comprises a small build platform area or build platform or build plate. In some exemplary embodiments, the build platform is a surface to which the printed part adheres during the printing process. In some exemplary embodiments, the build platform is configured to support the printed part during the printing process. In some exemplary embodiments, the build platform allows for application-specific containers to minimize resin waste during small print batches. In some exemplary embodiments, the container and build platform may come in a type of cartridge that is used up to build specific components, for example, a dental appliance. Once built, the cartridge-based resin tank and build platform or cartridge is used up and thrown out, that is disposable, or recycled.

In some exemplary embodiments, the cartridge-based resin tank further comprises a print screen or print surface. In some exemplary embodiments, the print screen is the surface that allows light to pass through to cure the resin. The print screen is bonded with the cured resin. The bond between the print screen and resin is weak enough that the part can be separated from the print screen in order to print the next layer. In some exemplary embodiments, the print occurs inside the cartridge-based resin tank that is pre-filled with the resin. In some exemplary embodiments, the build platform and print screen are incorporated into the sealed, prefilled cartridge-based resin tank of light cured resin.

In some exemplary embodiments, the build platform may be located internal or external to the cartridge-based resin tank. In some exemplary embodiments, the build platform is incorporated into the cartridge-based resin tank. In this arrangement, the cartridge-based resin tank houses the resin and the build platform. In some exemplary embodiments, a Z axis arm of the 3D printer houses a mating arrangement. The mating arrangement is configured to mate with the build platform in the cartridge-based resin tank and breaks the seal for the resin in the cartridge-based resin tank. Once the print is finished, the printed part is removed from the print screen and the build platform can be discarded. In this type of build platform configuration, the platform arm and the external printer features get very little resin exposure and do not require user cleaning.

In another embodiment, the build platform resides external to the cartridge-based resin tank. In some exemplary embodiments, the build platform may be located on the Z axis arm of the 3D printer. In this arrangement, the build platform resides on the Z axis arm. In some exemplary embodiments, the build platform has an arrangement that allows it to puncture the seal on the top side of the cartridge-based resin tank and access the resin to initiate the printing process.

In some exemplary embodiments, the build platform interacts with the penetrable layer or sealing surface in different methods to access the resin. The interaction methods may include a puncture interaction method and a built-in platform interaction method. In puncture interaction method, the sealing surface of the cartridge-based resin tank is punctured by the build platform. In some exemplary embodiments, the puncture is designed to eliminate the contamination of the resin from the seal.

In built-in platform interaction method, the build platform resides inside of the cartridge-based resin tank. In some exemplary embodiments, a mechanism associated with the Z axis arm interacts with the build platform and clutches the build platform to initiate the printing process. In some exemplary embodiments, the build platform punctures the penetrable layer before initiating the printing process. In another embodiment, the penetrable layer moves and flexes according to the printing cycle. In some exemplary embodiments, the penetrable layer is made of a flexible material.

In some exemplary embodiments, the cartridge-based resin tank is used with one or more adapters to house the resin vat. The adapter may interact with the cartridge-based resin tank through either a mechanical fastening or a magnetic fastening. In some exemplary embodiments, the adapter may be a fixed part or a removable part.

In another embodiment, a single DLP printer is used to print with multiple materials at once. The single DLP printer comprises a platform that can be split but not have independent z-axis controls. In some exemplary embodiments, the single DLP printer comprises a container. In some exemplary embodiments, the container may be a disposable tank that holds the print resin during the printing process. In some exemplary embodiments, the container is pre-filled with light-cured resin for the printing process. In some exemplary embodiments, the container comprises one or more compartments configured to hold the print resin during the printing process. The container physically separates the resin into separate compartments. This can be done with a divider on a single part of the use of multiple containers.

In some exemplary embodiments, the container further comprises a build platform or build plate. In some exemplary embodiments, the build platform is the surface that the printed part adheres during the printing process. In some exemplary embodiments, the container and the build platform may come in a type of cartridge that is used up to build specific components, for example, a dental appliance. In some exemplary embodiments, the container further comprises a print screen. In some exemplary embodiments, the print screen is the surface that allows light to pass through to cure the resin. The print screen is bonded with the cured resin. The bond is weak enough that the part can be separated from the screen in order to print the next layer. In some exemplary embodiments, the build platform further comprises at least one built-in heater to achieve a faster heat up time.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A illustrates a block diagram for a system in accordance with some exemplary embodiments of the present invention.

FIG. 1B illustrates a cut-sectional view of a cartridge in accordance with some exemplary embodiments of the present invention.

FIG. 1C illustrates the operation of a cartridge in accordance with some exemplary embodiments of the present invention.

FIG. 2 illustrates a system in accordance with some exemplary embodiments of the present invention.

FIG. 3-FIG. 5 illustrate an adapter and adapter components for utilizing a cartridge in accordance with the present invention with conventional 3D printers.

FIG. 6 illustrates an exploded view of a cartridge in accordance with some exemplary embodiments of the present invention in which multiple products using different forming materials may be created during the same print job.

FIG. 7 illustrates a perspective view of a resin tank in accordance with some exemplary embodiments of the present invention.

FIG. 8-FIG. 9 illustrate different perspective views of a build platform of the 3D printer in some exemplary embodiments of the present invention.

FIG. 10 illustrates an exploded view of a cartridge in accordance with some exemplary embodiments of the present invention.

FIG. 11 illustrates a perspective view of a cartridge in accordance with the embodiment illustrated in FIG. 10.

FIG. 12-FIG. 17 illustrates different perspective views of adapters in accordance with some exemplary embodiments of the present invention.

### DETAILED DESCRIPTION OF EXAMPLE EMBODIMENT

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

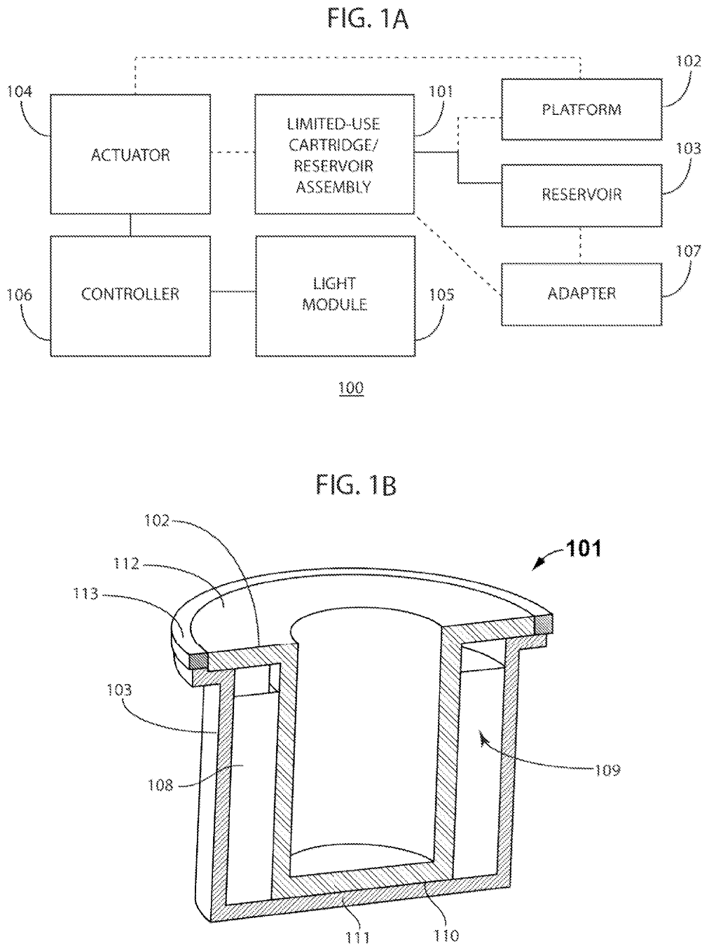

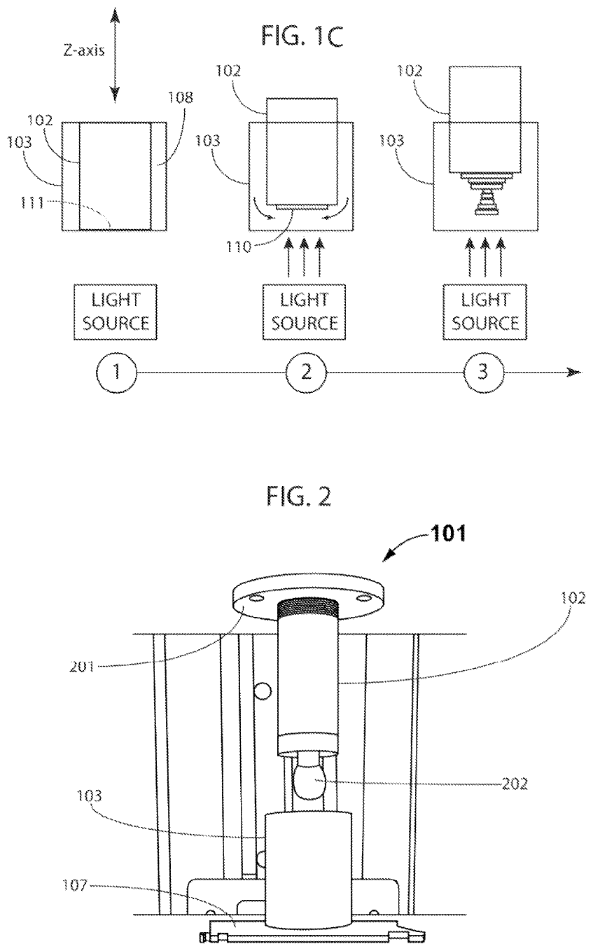

Turning first to FIG. 1, a block diagram for a system in accordance with some exemplary embodiments of the present invention is illustrated. More specifically, FIG. 1 depicts system 100, which includes a reservoir assembly 101, which houses a forming material such as a light-curable resin, a platform 102, which in some exemplary embodiments as discussed below may be a component of reservoir assembly 101 or a separate component than the reservoir assembly 101, a tank or reservoir 103 that houses the forming material and which generally is integral with the reservoir assembly 101, an actuator 104 for moving platform 102 along a z-axis in relation to the reservoir 103, a light module 105 for curing a layer of the forming material onto a surface of the platform or onto a previously cured layer of the forming material until a three-dimensional (3D) object is formed; and a controller 106 configured to actuate the platform and emit curable light into the reservoir in order to form the 3D object. Moreover, in some exemplary embodiments as will be discussed further below, one or more adapters 107 may be employed to adapt an existing additive manufacturing device such as a 3D printer, for utilizing a reservoir assembly in accordance with the present invention.

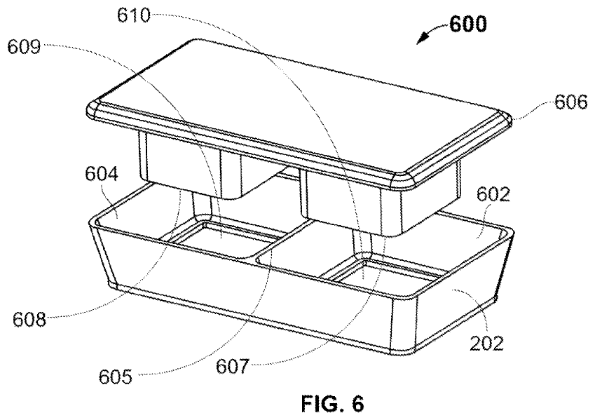

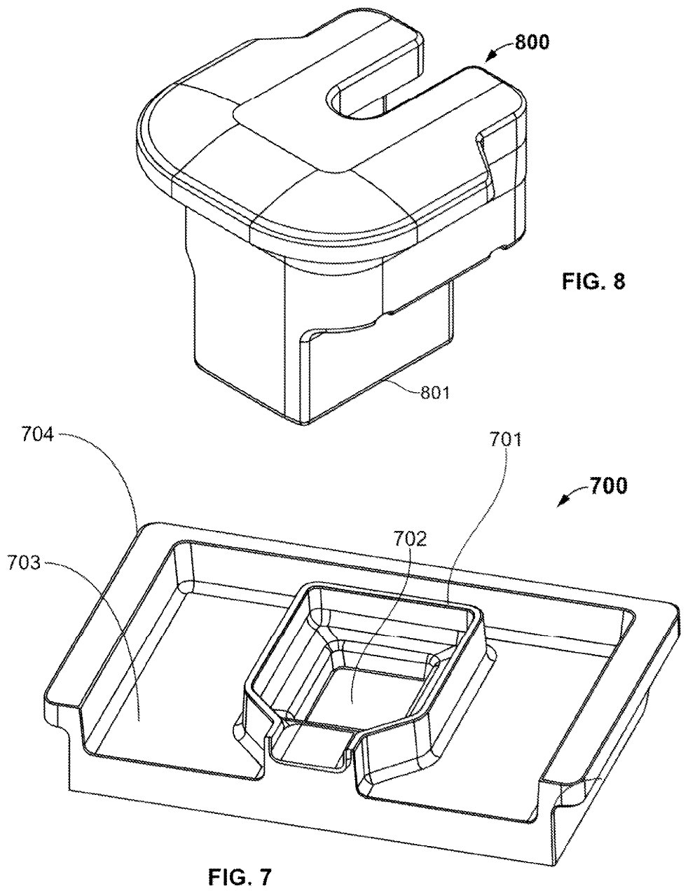

Reservoir assembly 101 is adapted to house a forming material such as a light-curable resin. In some exemplary embodiments, reservoir assembly 101 is a limited-use cartridge is pre-filled with enough forming material or resin to build a single 3D object such as, for example in the dental field, a single crown, a single dental appliance, or a single printable 3D object. In some exemplary embodiments, the cartridge is limited-use because once the 3D-printed object is formed, the cartridge may be disposed (i.e., single-use) or recycled. In embodiments of the present invention in which reservoir assembly 101 comprises a cartridge, the reservoir assembly 101 may comprise platform component that forms platform 102 on which the intended 3D object is formed or cured to during the forming process, and a reservoir component that forms reservoir 103 for securing and keeping fresh the forming material or resin intended to be used to form the 3D object. For example, and without limiting the scope of the present invention, see FIG. 1B, FIG. 6,

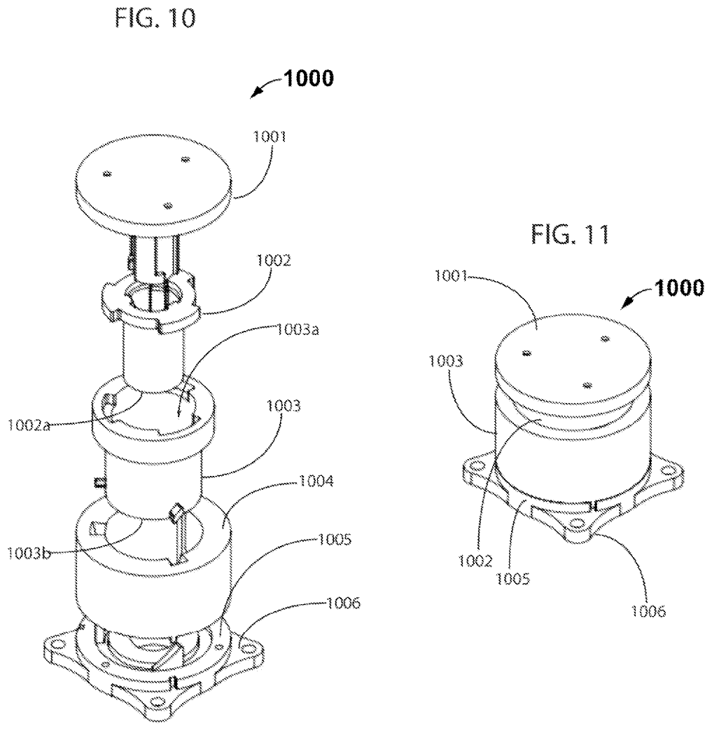

FIG. 10, and FIG. 11, showing different embodiments of a limited-use cartridge in accordance with the present invention that include both a platform and reservoir within the cartridge or reservoir assembly.

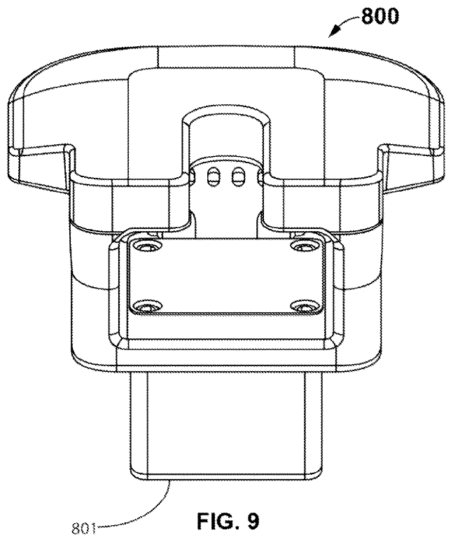

In yet other exemplary embodiments in accordance with the present invention, for example as shown in FIG. 7, FIG. 8, and FIG. 9, a reservoir assembly 101 may exclude platform 102. In embodiments in which reservoir assembly 101 excludes platform 102, system 100 nevertheless utilizes platform 102, except that platform 102 is a separate component—not integral with reservoir assembly 101—which is similarly actuated with actuator 104 that is configured to move platform 102 along a z-axis in relation to reservoir 103. Reservoir 103 is, in such exemplary embodiments, integral with reservoir assembly 101 so that a portion of reservoir assembly 101 forms the reservoir 103 that holds or houses the forming material or resin for forming the intended 3D object.

Platform 102, whether integral with or separate from reservoir assembly 101, includes a build surface adapted to receive a layer of the forming material that is typically cured onto the build surface to support the 3D object that is built onto the platform 102. As such, platform 102 should be constructed of a suitable material as it is understood in the art of additive manufacturing that is compatible with printing or forming materials.

Reservoir 103 is generally integral with or form part of reservoir assembly 101 and typically includes a transparent surface that both holds the forming material inside the reservoir 103 and allows a curing light through in order to cure a layer of the forming material onto the platform or onto a previously cured layer of the forming material in order to form or build the 3D object from the forming material onto the platform.

Actuator 104 is generally any suitable motor or movable component that may be configured to move platform 102 along a z-axis in relation to reservoir 103 during a forming or printing process to build the 3D object. In some exemplary embodiments, actuator 104 couples directly to a portion of the cartridge or reservoir assembly 101 (see for example FIG. 1B or FIG. 10). In some exemplary embodiments, for example in which reservoir assembly 101 is not a cartridge and does not include platform 102, actuator 104 may couple directly with a component of platform 102 that is external to reservoir assembly 101 in order to move the platform during the formation process.

Light module 105 may be any suitable light source for curing the forming material into the intended 3D object. For example, and without limiting the scope of the present invention, because different forming materials are activated by different types of energy, light module may implement different components to project the suitable light in order to cure the forming material inside reservoir assembly 101. Thus, while in some embodiments light module may employ components for using blue or ultraviolet light or any other appropriate wavelength based on the properties of forming material to activate the forming agent, it will be appreciated by one of ordinary skill in the art that when a forming material or agent is used that requires other forms of energy, e.g., infrared light, laser light, X-rays, gamma radiation and the like, the light module should be suitably modified to generate and output such required energy. Therefore, for example, when infrared is projected onto the forming agent, the appropriate hardware and software must be employed so that a projector of light module 105 can generate and project such infrared light. Likewise, if X-rays or gamma radiation is used, the projector may be replaced entirely by an energy emitter that can produce and emit the appropriate energy format onto the forming agent.

In some exemplary embodiments, light module 105 may include multiple light engines that may be used to increase the maximum build space while maintaining a desired resolution. In such embodiments, the light engines may be placed inside a pre-designed fixture to maintain them in place. In some other embodiments one or multiple light engines may be used and translated at the same time over the build space to maintain a resolution while having the maximum build space. In some exemplary embodiments, multiple light engines may be employed to print multiple products that come in a single reservoir assembly 101 such as a cartridge with dual reservoirs and dual platforms suitable for forming two 3D products during a single batch; this configuration may be useful for printing products that may require different components with different forming materials that would otherwise require forming in separate batches. For example, and without limiting or deviating from the scope of the present invention, a set of dentures may be formed in a single batch with one reservoir of the reservoir assembly dedicated for the gums component of the dentures which requires a first type of forming material, and a second reservoir of the reservoir assembly dedicated for the teeth component of the dentures which requires a second type of forming material. See FIG. 6 as a non-limiting example of a reservoir assembly suitable for holding two forming materials and printing multiple 3D objects in a single build batch.

Controller 106 is a suitable controller in charge of receiving model data from a remote computer or locally to process images and to drive actuator 104 and control light module 105 in order for system 100 to form the intended 3D objects. To these ends, while multiple configurations for controller 106 may be possible without deviating from the scope of the present invention, controller 106 is generally configured to actuate platform 102 and emit curable light into the reservoir 103 in order to form the intended 3D object for which a suitable amount of forming material is included in a limited-use or short term use reservoir assembly 101.

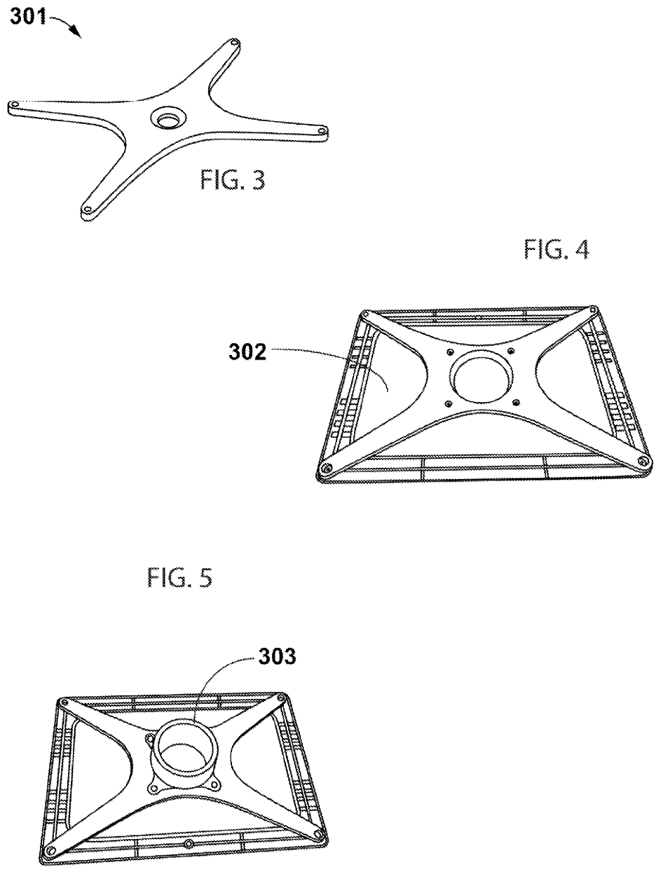

Moreover, in some exemplary embodiments as will be discussed further below, system 100 may include one or more adapters 107 for facilitating use of reservoir assembly 101 with conventional or existing additive manufacturing devices such as 3D-printers. For example, FIG. 3-FIG. 5 show an adapter assembly that retrofits or adapts a transparent substrate or glass of an existing light engine to receive a reservoir assembly or cartridge in accordance with some exemplary embodiments of the present invention. In another example, FIG. 7 shows an adapter that retrofits or adapts an existing tank to receive a reservoir assembly or cartridge in accordance with some exemplary embodiments of the present invention.

FIG. 1B illustrates a cut-sectional view of a cartridge in accordance with some exemplary embodiments of the present invention. More specifically, FIG. 1B illustrates a cut-sectional view of reservoir assembly 101, which is a cartridge in accordance with exemplary embodiments of the present invention. As will be described below, in the embodiment of FIG. 1B, the reservoir assembly or cartridge 101 includes both a reservoir 103 that holds a forming material or resin 108, as well as a platform 102 that is movably built into the cartridge 101. In this embodiment, cartridge 101 is pre-filled and sealed with light-cured resin 108. This embodiment of cartridge 101 allows operators to go through a print or build process with minimal resin handling and eliminates the need to measure the amount of resin during setup. In some exemplary embodiments, the resin 108 is in a form of liquid or paste. The resin 102 is hardened using visible and/or ultraviolet (UV) light.

In this embodiment, cartridge 101 includes an outer housing that at least partially forms reservoir 103 and is adapted to receive platform 102 inside the housing. In exemplary embodiments, a cavity 109 is formed between platform 102 and the interior walls of reservoir 103, wherein cavity 109 is prefilled with, or otherwise suitable to receive, resin 108. In exemplary embodiments, the bottom surface 110 of platform 102 is a build surface onto which the intended 3D object is cured during a build process. In a sealed or prior to use state, platform 102 is secured against a bottom surface 111 of reservoir 103, which is transparent, optically clear, or otherwise configured to allow the passage of curing light, for example UV light, to allow polymerization during use of cartridge 101.

In an initial stage, or prior to being used, cartridge 101 is preferably sealed so that surface 110 of platform 102 is secured against surface 111 of reservoir 103, thereby preserving an integrity of the resin holding cavity 109 so that resin 108 stays fresh inside cartridge 101 prior to use. During operation, as shown in FIG. 1C, at step (1) cartridge 101 is situated or placed so that the cartridge 101 may be exposed to a curing light from a light module of system 100. In step (2), platform 102 is lifted or otherwise moved along a z-axis with reference to reservoir 103, so that surface 110 of platform 102 separates from surface 111 of reservoir 103, allowing resin 108 to flow from cavity 109 into the space between surfaces 110 and 111 of platform 102 and reservoir 103, respectively. This may be achieved via activating actuator 104 that has been adapted to move platform 102, for example up and down, so that platform 102 is lifted away from and lowered back to reservoir 103. In exemplary embodiments, an adapter 107 is utilized in order to secure cartridge 101 to a securing structure, for example a transparent support plate of the light module 105. During or in between movement of platform 102 along the z-axis, light module may be activated to a emit curing light and cure a layer of the resin 108 onto a surface of the platform 110. In step (3), the process of moving platform 102 and directing a light from the light module 103 into the reservoir through transparent surface 111 is repeated so that a 3D object may be formed layer by layer inside reservoir 103.

In some exemplary embodiments, cartridge 101 further comprises a penetrable layer or sealing layer 112 on its top side. The penetrable layer 112 is configured to seal the resin and secure platform 102 in place. As mentioned above, build surface 110 is a surface to which the printed part adheres during the printing process. In some exemplary embodiments, build surface 110 is configured to support the built part during the forming process. In some exemplary embodiments, platform 102 may include a dimension of about 2500 mm² or less. In some exemplary embodiments, build surface 110 allows for usage of application-specific containers to minimize resin waste during small print batches. In some exemplary embodiments, cartridge 101 and build surface 110 may be provided as a type of cartridge that may be used to build specific components, for example, a dental appliance. Once built, the cartridge 101 and build surface 110 or cartridge may be used up and disposed of or recycled.

As mentioned above, cartridge 101 comprises a surface 111, which is generally a print screen. In some exemplary embodiments, the print screen is the surface that allows light to pass through to cure the resin 108. The print screen may be bonded with the cured resin 108 however, the bond between print screen and resin is generally weak so that the 3D printed part, or each layer formed thereof, can be separated from the print screen in order to form the next layer.

In some exemplary embodiments, formation of the 3D object 200 occurs inside cartridge 101 that is pre-filled with the resin 108 as shown in FIG. 2. In some exemplary embodiments, a Z axis arm of a 3D printer includes a mating arrangement 201. The mating arrangement 201 is configured to mate with platform 102 of cartridge 101 and breaks a seal for forming material inside cartridge 101. Once the forming of the 3D object is completed, the 3D object or 3D-printed part 202 may be removed from cartridge 101 and platform 102 can be discarded or recycled. In this type of build platform configuration, a platform arm and the external additive manufacturing device components get very little exposure to the forming material (e.g., resin) and do not require user cleaning.

In another embodiment, the build surface 110 resides external to the cartridge 101. In some exemplary embodiments, the build surface 110 may be located on the Z axis arm of the 3D printer. In this arrangement, the build surface 110 resides on the Z axis arm. In some exemplary embodiments, build surface 110 has an arrangement that allows it to puncture the seal on the top side of the cartridge 101 and access the resin 102 to initiate the printing process.

In some exemplary embodiments, platform 102 interacts with a penetrable layer or sealing surface in different methods to access the forming material. The interaction methods may include a puncture interaction method and a built-in platform interaction method. In a puncture interaction method, the sealing surface of cartridge 101 may be punctured by the platform. In some exemplary embodiments, the puncture is designed to eliminate the contamination of resin from the seal.

In a built-in platform interaction method, the platform resides inside of cartridge 101. In some exemplary embodiments, a mechanism associated with the Z axis arm interacts with the platform and clutches the platform to initiate the printing process. There may be a couple of variations of this system. In some exemplary embodiments, the platform punctures a penetrable layer before initiating the printing process. In another embodiment, the penetrable layer moves and flexes according to the printing cycle. In some exemplary embodiments, the penetrable layer is made of a flexible material.

Referring to FIG. 3-FIG. 5, an adapter assembly is illustrated. More specifically, the adapter assembly shown is configured to retrofit or adapt an existing transparent substrate or glass of a light engine to receive a reservoir assembly or cartridge in accordance with some exemplary embodiments of the present invention. In exemplary embodiments, adapter components (108, 110, and 112) may interact with the cartridge 101 through either a mechanical fastening or a magnetic fastening. In some exemplary embodiments, the adapter components (108, 110, and 112) may be a fixed part, where it becomes a part of the additive manufacturing device, such as an existing 3D printer. In another embodiment, the adapter components (108, 110, and 112) may include removable parts, where the components sit securely on the printer and can be accessed or moved by the user.

For example, and without deviating from the scope of the present invention, FIG. 3 shows an exemplary reservoir assembly adapter frame 301 configured to couple to a screen or transparent plate 302 of a 3D printer, or a light module of a 3D printer (not shown). The reservoir assembly adapter frame 301 is also configured to receive a cartridge holder 303 shown in FIG. 5, to which a cartridge or reservoir assembly of a cartridge in accordance with the present invention may be secured to.

Referring to FIG. 6, an exploded view of a cartridge 600 of a single DLP printer is illustrated. In some exemplary embodiments, the single DLP printer is used to print with multiple materials at once. The single DLP printer comprises a platform that can be split but does not have independent z-axis controls. In some exemplary embodiments, cartridge 600 may be a disposable reservoir assembly that holds the print resin or forming material during the forming or printing process. In some exemplary embodiments, cartridge 600 is pre-filled with light-curable resin; in some exemplary embodiments, multiple types of curable resin may be sealed and stored in cartridge 600. To these ends, cartridge 600 comprises one or more compartments (602 and 604). The cartridge 600 physically separates the resin into separate compartments (602 and 604), which may be achieved with a divider 605.

In some exemplary embodiments, the cartridge 600 further comprises a platform 606 that includes multiple build surfaces 607 and 608. Cartridge 600 is similar to cartridge 101 as discussed above but includes multiple (i.e., in this case dual) reservoirs and dual built-in build surfaces 607 and 608 suitable for building components of a 3D-printed part that may require different materials or different parts, for example a set of dentures or a dental appliance. In some exemplary embodiments, cartridge 600 further comprises dual print screens or bottom surfaces 609 and 610 that are transparent and function similarly to surface 111—holding the forming material inside cartridge 600 and allowing suitable light to pass through in order to cure the forming material therein for building the intended 3D objects.

Referring to FIG. 7, a perspective view of a resin tank or reservoir assembly 700 is illustrated. Reservoir assembly 700 may be provided sealed and prefilled with resin, or may be simply provided for the user to fill with forming material as required. As such, this is an alternative to a cartridge configuration of the present invention, but to an embodiment in which a reservoir assembly is used in conjunction with a separate platform configured to register with reservoir assembly 700. In some exemplary embodiments, reservoir assembly 700 includes a reservoir 701 that is smaller in volume than conventional forming material tanks. The small volume is constrained to accommodate for a single model build. Reservoir assembly 700 is configured to house or hold a light curable resin or forming material. In some exemplary embodiments, reservoir 701 of reservoir assembly 700 is prefilled with forming material. In some exemplary embodiments, reservoir 701 of reservoir assembly 700 is geared towards maximizing the resin height with minimal cross-sectional area configured to optimize for the amount of resin being used.

In some exemplary embodiments, the minimal cross-sectional area of reservoir 701 supports up to one single 3D-printed object. For example, the minimal cross-sectional area is adapted to receive just enough forming material to build a single crown. The reduction in cross sectional area along with a build platform 800 (shown in FIG. 8) leads to displacement of the resin, allowing for easier flowing of the resin. In some exemplary embodiments, reservoir assembly 700 comprises a smaller print surface or print screen 702. In some exemplary embodiments, the smaller print screen allows for usage of alternate materials for optically clear printing surface.

In exemplary embodiments, as shown in the view of FIG. 7, an outer or surrounding surface 703 is configured to sit on a conventional forming material tank so that a conventional 3D printer, for example, may be retrofitted to be used with reservoir assembly 700 and thus in accordance with the present invention. A frame 704 may exemplarily support the surrounding surface 703 and hence the reservoir 701 of the reservoir assembly 700. During use, the reservoir assembly 700 may be simply placed over a conventional tank.

Referring to FIG. 8-9, different perspective views of a build platform 800 are illustrated. The build platform 800 is identical to a larger build platform. In some exemplary embodiments, build platform 800 comprises a z-axis arm. In some exemplary embodiments, build platform 800 further comprises a print area 801. Print area 801 of the build platform 800 may be modified to fit in the print screen 702 of reservoir assembly 700. In some exemplary embodiments, build platform 800 further comprises at least one built-in heater, for example a heater such as is described in U.S. patent application Ser. No. 17/990,256, which is incorporated by reference. Build platform 800 may employ a larger surface area exposed to the resin to achieve a faster heat up time.

Turning now to the next set of figures, FIG. 10 illustrates an exploded view of a cartridge in accordance with some exemplary embodiments of the present invention, and FIG. 11 illustrates a perspective view of a cartridge in accordance with the embodiment illustrated in FIG. 10. More specifically, cartridge 1000 is shown, including a platform adapter 1001 that both seals the cartridge and provides a connection means to an actuator or movement arm of an additive manufacturing device such as a 3D printer, a platform 1002, a reservoir assembly 1003 that is adapted to register with platform 1002, a reservoir assembly adapter body 1004 configured to receive at least a portion of the reservoir assembly 1003 of the cartridge 1001, a locking or releasing mechanism 1005, and an adapter base 1006 configured to secure cartridge 1001 to the additive manufacturing or printing device (not shown).

In some exemplary embodiments, cartridge 1000 comprises a single-use cartridge for building a three-dimensional (3D) object using an additive manufacturing device. In exemplary embodiments, the cartridge includes a reservoir assembly 1003 including a reservoir 100 sealed and prefilled with a forming material; a transparent layer 100 adapted to hold the forming material inside the reservoir 100, the transparent layer 100 further adapted to allow polymerizing light to pass through for polymerization of at least a layer of the forming material; and a platform 1002 slidably housed inside the reservoir assembly adapted to move vertically along a z-axis in relation to the transparent layer 100 and adapted to support a 3D object built on a surface 100 of the platform 1002.

In some exemplary embodiments, reservoir 100 includes a divider (not shown in this view, but see FIG. 7) that divides the reservoir into multiple reservoirs adapted to hold one or more types of forming materials; and the platform includes multiple build surfaces adapted to register with each of the multiple reservoirs.

In some exemplary embodiments, a cavity is formed between the platform and the reservoir assembly to hold the forming material inside the cavity. In some exemplary embodiments, movement of the platform during use of the cartridge exposes the forming material inside the cavity to the built surface of the platform (see for example, FIG. 1C).

In some exemplary embodiments, cartridge 1001 further comprises a penetrable layer or sealing surface on a top side or bottom side of the cartridge configured to secure the platform inside the reservoir when the cartridge is in a sealed state. In some exemplary embodiments, the sealing surface is made of a flexible material that moves and flexes according to a forming cycle.

In some exemplary embodiments, cartridge includes platform adapter 1001, which is configured to connect the platform to an actuator of the additive manufacturing device (for example a print arm (not shown in tis view)). In some exemplary embodiments, platform adapter 1001 is configured to puncture a penetrable layer sealing the forming material inside reservoir 100 of reservoir assembly 1003.

In some exemplary embodiments, as shown, cartridge 1001 further includes reservoir assembly adapter 1005 configured to secure the reservoir assembly 1003 to a light module of the additive manufacturing device. In some exemplary embodiments, the reservoir assembly adapter 1005 interacts with the reservoir assembly via a mechanical fastener or a magnetic fastener device incorporated therein. A base 1006 may be configured to secure the adapter in place to a preexisting printer or additive manufacturing device.

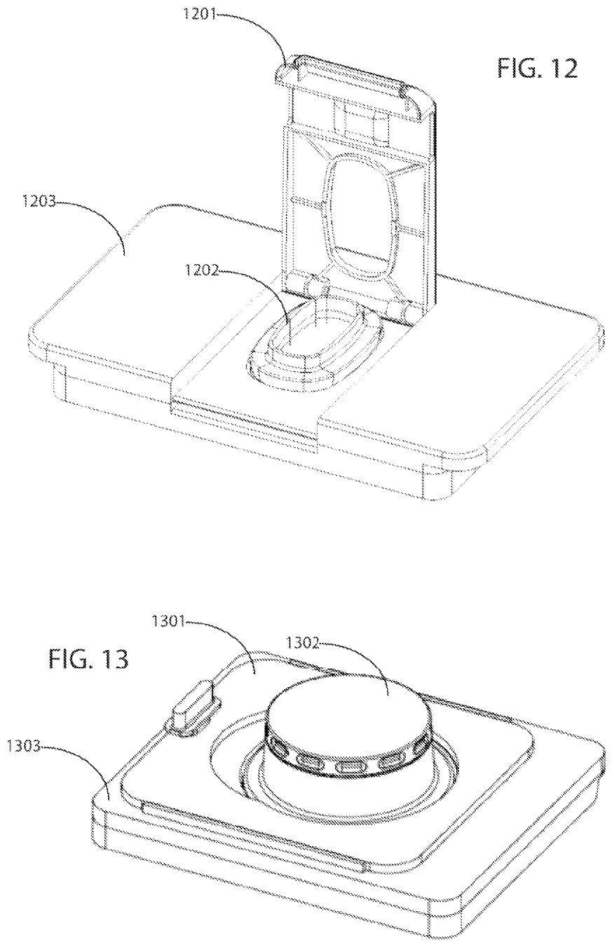

FIG. 12-FIG. 17 illustrates different perspective views of adapters in accordance with some exemplary embodiments of the present invention. More specifically, these figures show different types of adapters that secure a cartridge in accordance with the present invention to an existing printer or additive manufacturing device.

FIG. 12 shows a latch-based assembly, which includes a latch locking mechanism 1201, a cartridge receiving aperture 1202, and an adapter base 1203. In this mechanism, the cartridge is grabbed by a latch built onto the adapter. This latch can open to the top or to the sides.

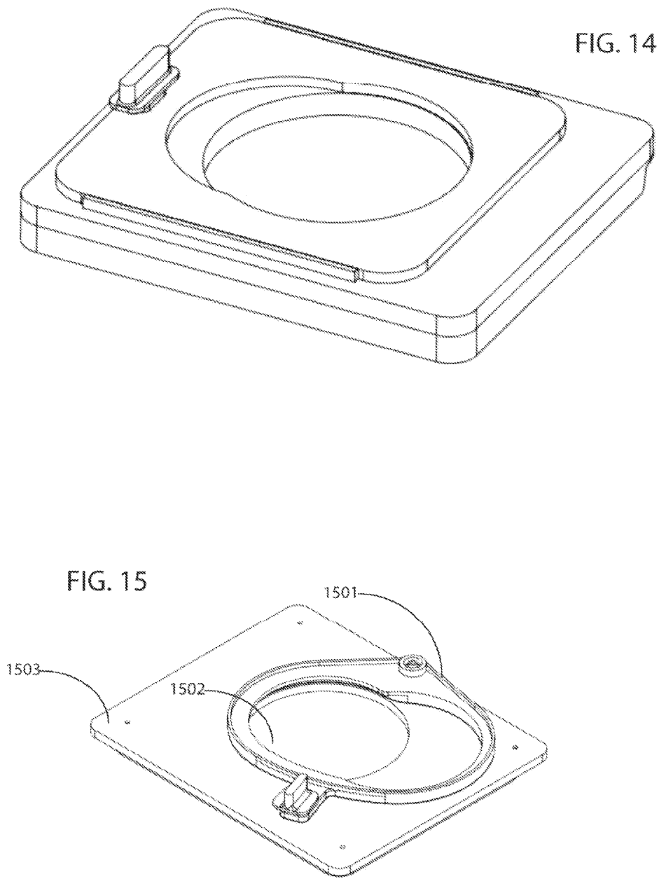

FIG. 13 shows a slider-based assembly, which includes a cartridge receiving aperture 1302 (shown with a cartridge secured therein), a latch locking mechanism 1301, and an adapter base 1303. In this mechanism, the cartridge is held by a feature on the adapter which is engaged/disengaged with the help of a slider. FIG. 14 shows the same components without the cartridge installed therein.

FIG. 15 shows a swing-based assembly, which includes a cartridge receiving aperture 1502, a locking mechanism 1501, and an adapter base 1503. In this mechanism, a swing on the adapter is used to engage/disengage the cartridge. The swing can be operated manually by the user or can be engaged electronically.

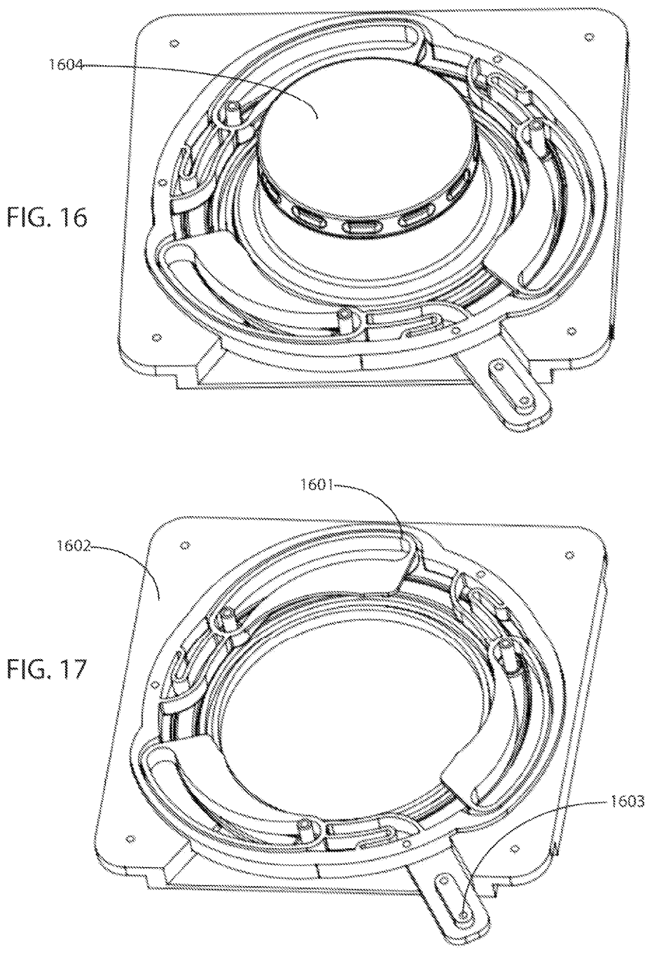

FIG. 16 and FIG. 17 show an aperture-based assembly, which includes a cartridge receiving aperture 1600, shown with a cartridge 1604, an aperture locking mechanism 1601, and an adapter base 1603. In this mechanism, the cartridge is engaged/disengaged via mechanical features similar to one employed by a camera. The aperture is decreased to engage the cartridge and is increased to disengage. This mechanism can be triggered manually by the user or electronically.

Advantageously, the container of the present invention allows operators to go through the printing process with minimal resin handling, which eliminates the need to measure the resin during setup. The build platform arm and the external printer features get very little resin exposure and do not require user cleaning. The build platform is utilized for application-specific containers to minimize the resin waste during the small print batches. The container is used to print with multiple materials at once. Further, the container and build platform are disposable or single use.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A kit for retrofitting an existing three-dimensional (3D) printer, the existing 3D printer including an existing resin reservoir including an existing bottom print surface, the existing resin reservoir adapted to register with an existing screen adapted to provide a curing light, the existing bottom print surface, when the existing resin reservoir is registered with the existing screen, covering a first portion of the existing screen and configured to receive the curing light from the first portion of the existing screen, the kit comprising:
a kit adapter including a kit resin reservoir including a kit bottom print surface, the kit adapter adapted to register with the existing screen,
the kit bottom print surface, when the kit adapter is registered with the existing screen, covering a second portion of the existing screen and configured to receive the curing light from the second portion of the existing screen only,
wherein the second portion of the existing screen is contained within the first portion of the existing screen.

2. The kit of claim 1 wherein a total surface area of the second portion of the existing screen is smaller than a total surface area of the first portion of the existing screen.

3. The kit of claim 1 further comprising:
a kit cover configured to cover a portion of the first portion of the existing screen not covered by the kit bottom print surface.

4. The kit of claim 3, wherein the kit cover is attached to the kit adapter.

5. The kit of claim 1, wherein the existing 3D printer includes an existing build platform including an existing build surface with an existing build surface surface area, the kit further comprising:
a kit build platform including a kit build surface with a kit build surface surface area that is smaller than the existing build surface surface area, the kit build platform interchangeable with the existing build platform.

6. The kit of claim 5, wherein the kit build surface surface area is less than a surface area of the kit bottom print surface.

7. The kit of claim 5 wherein the kit bottom print surface includes a kit bottom surface perimeter, and the kit build surface includes a kit build surface perimeter that fits within the kit bottom surface perimeter.

8. The kit of claim 1 wherein the kit resin reservoir is removable from the kit adapter.

9. The kit of claim 1 wherein the kit bottom print surface is transparent and/or semi-transparent.

10. The kit of claim 1 wherein the kit resin reservoir is prefilled with an amount of photosensitive resin and is sealed using a sealing member with the amount of photosensitive resin therein.

11. A method of retrofitting an existing three-dimensional (3D) printer, the existing 3D printer including an existing resin reservoir including an existing bottom print surface, the existing resin reservoir adapted to register with an existing screen adapted to provide a curing light, the existing bottom print surface, when the existing resin reservoir is registered with the existing screen, covering a first portion of the existing screen and configured to receive the curing light from the first portion of the existing screen, the method comprising:
providing a kit adapter including a kit resin reservoir including a kit bottom print surface, the kit adapter adapted to register with the existing screen;
registering the kit adapter with the existing screen thereby covering a second portion of the existing screen with the kit bottom print surface and thereby configuring the kit bottom surface to receive the curing light from the second portion of the existing screen only;
wherein the second portion of the existing screen is contained within the first portion of the existing screen.

12. The method of claim 11, wherein a total surface area of the second portion of the existing screen is smaller than a total surface area of the first portion of the existing screen.

13. The method of claim 11 further comprising:
covering, with a kit cover, a portion of the first portion of the existing screen not covered by the kit bottom print surface.

14. The method of claim 13, wherein the kit cover is attached to the kit adapter.

15. The method of claim 11, wherein the existing 3D printer includes an existing build platform including an existing build surface with an existing build surface surface area, the method further comprising:
interchanging the existing build platform with a kit build platform including a kit build surface with a kit build surface surface area that is smaller than the existing build surface surface area.

16. The method of claim 15, wherein the kit build surface surface area is less than a surface area of the kit bottom print surface.

17. The method of claim 15 wherein the kit bottom print surface includes a kit bottom surface perimeter, and the kit build surface includes a kit build surface perimeter that fits within the kit bottom surface perimeter.

18. The method of claim 11 wherein the kit resin reservoir is removable from the kit adapter.

19. The method of claim 11 wherein the kit bottom print surface is transparent and/or semi-transparent.

20. The method of claim 11 further comprising:
filling the kit resin reservoir with an amount of photosensitive resin; and
sealing, using a sealing member, the kit resin reservoir with the amount of photosensitive resin therein.
